(19) United States
(12) Patent Application Publication
(10) Pub. No.: US 2018/0249176 A1
(43) Pub. Date: Aug. 30, 2018

(54) METHOD AND APPARATUS FOR ENCODING AND DECODING VIDEO SIGNAL

(71) Applicant: LG Electronics Inc., Seoul (KR)

(72) Inventors: Jaehyun LIM, Seoul (KR); Seungwook PARK, Seoul (KR); Naeri PARK, Seoul (KR); Sunmi YOO, Seoul (KR)

(21) Appl. No.: 15/557,389

(22) PCT Filed: Oct. 28, 2015
(86) PCT No.: PCT/KR2015/011442

§ 371 Date: Sep. 11, 2017

Related U.S. Application Data
(60) Provisional application No. 62/131,268, filed on Mar. 11, 2015.
(60) Provisional application No. 62/135,170, filed on Mar. 19, 2015.

(51) Int. Cl. H04N 19/58; H04N 19/139; H04N 19/11; H04N 19/119; H04N 19/176

(52) U.S. Cl. CPC H04N 19/58; H04N 19/139; H04N 19/176; H04N 19/119; H04N 19/11

(57) ABSTRACT

The present invention provides a method for processing a video signal. The method includes: determining an optimal collocated picture based on the reference index of at least one of candidate blocks for predicting motion information of a current block; predicting motion information of the current block based on information of a collocated block within the optimal collocated picture; and generating a motion prediction signal based on the predicted motion information.

### CROSS-REFERENCE TO RELATED APPLICATIONS

This application is the National Stage filing under 35 U.S.C. 371 of International Application No. PCT/KR2015/011442, filed on Oct. 28, 2015, which claims the benefit of U.S. Provisional Applications No. 62/131,268, filed on Mar. 11, 2015 and No. 62/135,170, filed on Mar. 19, 2015, the contents of which are all hereby incorporated by reference herein in their entirety.

### TECHNICAL FIELD

The present invention relates to a method and apparatus for encoding and decoding a video signal, and more particularly, to a method for predicting motion information.

### BACKGROUND ART

Compression coding refers to a series of signal processing technologies for transmitting digitalized information through a communication line or storing the digitalized information in a form appropriate for a storage medium. Media such as video, an image, voice, and the like, may be the subject to compression coding, and in particular, a technology for performing compression coding on video is called video compression.

Next-generation video content is expected to feature high spatial resolution, a high frame rate, and high dimensionality of scene representation. The processing of such content will bring about a significant increase in message storage, a memory access rate, and processing power.

Thus, a coding tool for effectively processing next-generation video content is required to be designed.

Particularly, in the case of inter-prediction, directional information on reference picture lists L0 and L1, reference picture indices, and motion vectors need to be sent to the decoder. In this case, the amount of data sent can be reduced by predicting the motion information more efficiently.

### DISCLOSURE

### Technical Problem

The present invention proposes a method for reducing motion-related data.

The present invention proposes various methods for predicting motion information.

The present invention is intended to newly define a candidate area for predicting motion information.

The present invention proposes various methods for signaling motion information.

### Technical Solution

The present invention provides a method for predicting motion information from an optimal candidate area.

Furthermore, the present invention provides a method for obtaining motion information from an arbitrary area within a collocated prediction block.

Furthermore, the present invention provides a method for scaling the motion vector of a temporal candidate block.

Furthermore, the present invention provides a method for selecting a temporal candidate block for deriving a motion vector prediction value from within/outside a collocated block when motion information of a reference picture is compressed.

### Advantageous Effects

The present invention may compress a video signal more efficiently and reduce the amount of motion-related data to be sent, by proposing a method for predicting motion information.

### DESCRIPTION OF DRAWINGS

FIG. 1 is a schematic block diagram of an encoder encoding a video signal according to an embodiment to which the present disclosure is applied.

FIG. 2 is a schematic block diagram of a decoder decoding a video signal according to an embodiment to which the present disclosure is applied.

FIG. 3 is a view illustrating a partition structure of a coding unit according to an embodiment to which the present disclosure is applied.

FIG. 4 is a view illustrating a prediction unit according to an embodiment to which the present disclosure is applied.

FIG. 5 is a view illustrating a method for deriving motion information using spatial correlation according to an embodiment to which the present disclosure is applied.

FIG. 6 is a view illustrating a method for deriving motion information using temporal correlation according to an embodiment to which the present disclosure is applied.

FIG. 7 is a view illustrating a method for scaling a motion vector based on temporal correlation according to an embodiment to which the present disclosure is applied.

FIG. 8 is a flowchart illustrating a method for deriving a motion vector prediction value from a neighboring block according to an embodiment to which the present disclosure is applied.

FIG. 9 is a view illustrating a spatial candidate block for deriving a motion vector prediction value according to an embodiment to which the present disclosure is applied.

FIG. 10 is a view illustrating a temporal candidate block for deriving a motion vector prediction value from within a collocated block according to an embodiment to which the present disclosure is applied.

FIG. 11 is a view illustrating a temporal candidate block for deriving a motion vector prediction value from outside a collocated block according to an embodiment to which the present disclosure is applied.

FIG. 12 is a view illustrating a change in the areas of temporal candidate blocks for deriving a motion vector prediction value from within/outside a collocated block in a case where motion information of a reference picture is compressed, according to an embodiment to which the present disclosure is applied.

FIG. 13 is a method for selecting a temporal candidate block for deriving a motion vector prediction value from within/outside a collocated block in a case where motion information of a reference picture is compressed, according to an embodiment to which the present disclosure is applied.

FIG. 14 is a view illustrating a method for obtaining motion information from an arbitrary area within a collocated prediction block according to an embodiment to which the present disclosure is applied.

FIG. 15 is a view illustrating a method for scaling the motion vector of a temporal candidate block according to an embodiment to which the present disclosure is applied.

FIG. 16 is a flowchart illustrating a method for predicting motion information from an optimal candidate area according to an embodiment to which the present invention is applied.

### BEST MODE FOR INVENTION

The present invention provides a method for processing a video signal, the method including: determining an optimal collocated picture based on the reference index of at least one of candidate blocks for predicting motion information of a current block; predicting motion information of the current block based on information of a collocated blocks within the optimal collocated picture; and generating a motion prediction signal based on the predicted motion information.

Furthermore, in the present invention, the information of the collocated block is obtained from an area that is set with respect to the right bottom of the collocated block.

Furthermore, in the present invention, the information of the collocated block includes internal information of the collocated block, wherein the internal information comprises at least one of the following: a right bottom corner area; a right boundary area; a bottom boundary area; a right bottom quarter area; a right top corner area; a left bottom corner area; a center area; a preset specific area; or a combination thereof, which exist within the collocated block.

Furthermore, in the present invention, the information of the collocated block includes external information of the collocated block, wherein the external information comprises at least one of the following: a right bottom corner area; a right boundary area; a bottom boundary area; a right bottom quarter area; a right top corner area; a left bottom corner area, a center area of the block on the right bottom; a preset specific area; or a combination thereof, which exist within the area of the blocks on the right, bottom, and right bottom adjacent to the collocated block and are adjacent to the collocated block.

Furthermore, in the present invention, in a case where motion information of the optimal collocated picture is compressed, the motion information of the current block is predicted from an external area of a coding unit containing the collocated block.

Furthermore, in the present invention, the external area includes at least one of the following: a right top corner area, a right bottom corner area, a left bottom corner area, or a combination thereof, which are adjacent to the coding unit.

Furthermore, in the present invention, in a case where motion information of the optimal collocated picture is compressed, the motion information of the current block is predicted based on a distance between a specific position and a candidate area.

Furthermore, in the present invention, the specific position is preset based on the form of the collocated block or the form of a coding unit containing the collocated block.

Furthermore, in the present invention, if the collocated block is in the form of 2N×nU and motion information of the optimal collocated picture is compressed to a size of N×N, the specific position is the right bottom boundary or the left top boundary.

Furthermore, in the present invention, the method further includes receiving a flag indicating whether motion information of the optimal collocated picture is compressed or not.

Furthermore, in the present invention, the flag is received from at least one among a sequence parameter set, a picture parameter set, an adaptation parameter set, and a slice header.

Furthermore, in the present invention, the information of the collocated block is scaled by considering a temporal distance between the current picture containing the current block and the optimal collocated picture.

Furthermore, in the present invention, the candidate blocks for predicting motion information include at least one among an AMVP (advanced motion vector predictor) candidate block, a merge candidate block, and a neighboring block with respect to the current block.

Furthermore, the present invention provides an apparatus for processing a video signal, comprising a prediction unit that determines an optimal collocated picture based on the reference index of at least one of candidate blocks for predicting motion information of a current block, predicts motion information of the current block based on information of a collocated block within the optimal collocated picture, and generates a motion prediction signal based on the predicted motion information.

### MODE FOR INVENTION

Hereinafter, exemplary elements and operations in accordance with embodiments of the present invention are described with reference to the accompanying drawings. The elements and operations of the present invention that are described with reference to the drawings illustrate only embodiments, which do not limit the technical spirit of the present invention and core constructions and operations thereof.

Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be construed as being based on only the name of a term used in a corresponding description of this specification and that the present invention should be construed by checking even the meaning of a corresponding term.

Furthermore, terms used in this specification are common terms selected to describe the invention, but may be replaced with other terms for more appropriate analyses if other terms having similar meanings are present. For example, a signal, data, a sample, a picture, a frame, and a block may be properly replaced and interpreted in each coding process. And, partitioning, decomposition, splitting, and division may be properly replaced and interpreted in each coding process.

Furthermore, when a description in this specification is given of a process for an encoder or decoder, the same process may be applicable to a decoder as long as it can be performed by both the encoder and the decoder.

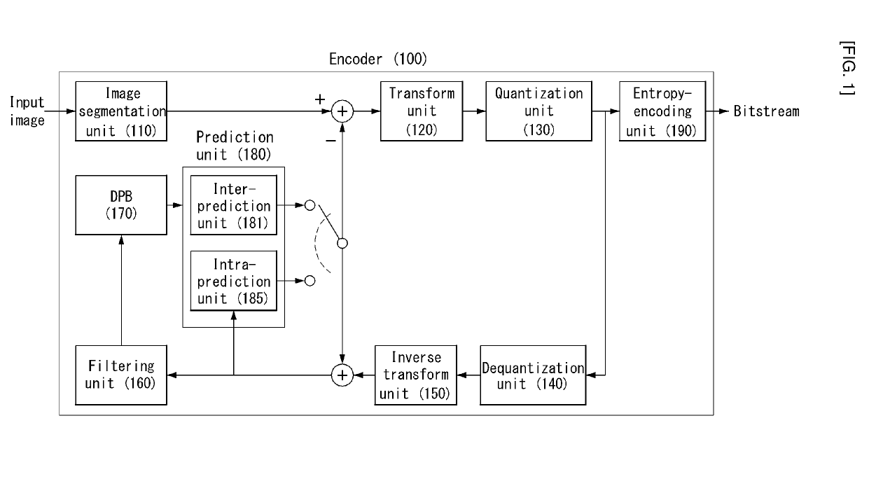

FIG. 1 shows a schematic block diagram of an encoder for encoding a video signal, in accordance with one embodiment of the present invention.

Referring to FIG. 1, an encoder 100 may include an image segmentation unit 110, a transform unit 120, a quantization unit 130, a dequantization unit 140, an inverse transform unit 150, a filtering unit 160, a DPB (Decoded Picture Buffer) 170, an inter-prediction unit 180, an intra-prediction unit 185 and an entropy-encoding unit 190.

The image segmentation unit 110 may divide an input image (or, a picture, a frame) input to the encoder 100 into one or more process units. For example, the process unit may be a coding tree unit (CTU), a coding unit (CU), a prediction unit (PU), or a transform unit (TU).

However, the terms are used only for convenience of illustration of the present disclosure. The present invention is not limited to the definitions of the terms. In this specification, for convenience of illustration, the term “coding unit” is employed as a unit used in a process of encoding or decoding a video signal. However, the present invention is not limited thereto. Another process unit may be appropriately selected based on contents of the present disclosure.

The encoder 100 may generate a residual signal by subtracting a prediction signal output from the inter-prediction unit 180 or intra prediction unit 185 from the input image signal. The generated residual signal may be transmitted to the transform unit 120.

The transform unit 120 may apply a transform technique to the residual signal to produce a transform coefficient. The transform process may be applied to a pixel block having the same size of a square, or to a block of a variable size other than a square.

The quantization unit 130 may quantize the transform coefficient and transmits the quantized coefficient to the entropy-encoding unit 190. The entropy-encoding unit 190 may entropy-code the quantized signal and then output the entropy-coded signal as bit streams.

The quantized signal output from the quantization unit 130 may be used to generate a prediction signal. For example, the quantized signal may be subjected to an inverse quantization and an inverse transform via the dequantization unit 140 and the inverse transform unit 150 in the loop respectively to reconstruct a residual signal. The reconstructed residual signal may be added to the prediction signal output from the inter-prediction unit 180 or intra-prediction unit 185 to generate a reconstructed signal.

Meanwhile, in the compression process, adjacent blocks may be quantized by different quantization parameters, so that deterioration of the block boundary may occur. This phenomenon is called blocking artifacts. This is one of important factors for evaluating image quality. A filtering process may be performed to reduce such deterioration. Using the filtering process, the blocking deterioration may be eliminated, and, at the same time, an error of a current picture may be reduced, thereby improving the image quality.

The filtering unit 160 may apply filtering to the reconstructed signal and then outputs the filtered reconstructed signal to a reproducing device or the decoded picture buffer 170. The filtered signal transmitted to the decoded picture buffer 170 may be used as a reference picture in the inter-prediction unit 180. In this way, using the filtered picture as the reference picture in the inter-picture prediction mode, not only the picture quality but also the coding efficiency may be improved.

The decoded picture buffer 170 may store the filtered picture for use as the reference picture in the inter-prediction unit 180.

The inter-prediction unit 180 may perform temporal prediction and/or spatial prediction with reference to the reconstructed picture to remove temporal redundancy and/or spatial redundancy. In this case, the present invention provides various embodiments for predicting motion information based on the correlation of motion information between a neighboring block and a current block, in order to reduce the amount of motion information transmitted in the inter-prediction mode.

Meanwhile, the reference picture used for the prediction may be a transformed signal obtained via the quantization and inverse quantization on a block basis in the previous encoding/decoding, thus, this may result in blocking artifacts or ringing artifacts.

Accordingly, in order to solve the performance degradation due to the discontinuity or quantization of the signal, the inter-prediction unit 180 may interpolate signals between pixels on a subpixel basis using a low-pass filter. In this case, the subpixel may mean a virtual pixel generated by applying an interpolation filter. An integer pixel means an actual pixel existing in the reconstructed picture. The interpolation method may include linear interpolation, bi-linear interpolation and Wiener filter, etc.

The interpolation filter may be applied to the reconstructed picture to improve the accuracy of the prediction. For example, the inter-prediction unit 180 may apply the interpolation filter to integer pixels to generate interpolated pixels. The inter-prediction unit 180 may perform prediction using an interpolated block composed of the interpolated pixels as a prediction block.

The intra-prediction unit 185 may predict a current block by referring to samples in the vicinity of a block to be encoded currently. The intra-prediction unit 185 may perform a following procedure to perform intra prediction. First, the intra-prediction unit 185 may prepare reference samples needed to generate a prediction signal. Then, the intra-prediction unit 185 may generate the prediction signal using the prepared reference samples. Thereafter, the intra-prediction unit 185 may encode a prediction mode. At this time, reference samples may be prepared through reference sample padding and/or reference sample filtering. Since the reference samples have undergone the prediction and reconstruction process, a quantization error may exist. Therefore, in order to reduce such errors, a reference sample filtering process may be performed for each prediction mode used for intra-prediction.

The prediction signal generated via the inter-prediction unit 180 or the intra-prediction unit 185 may be used to generate the reconstructed signal or used to generate the residual signal.

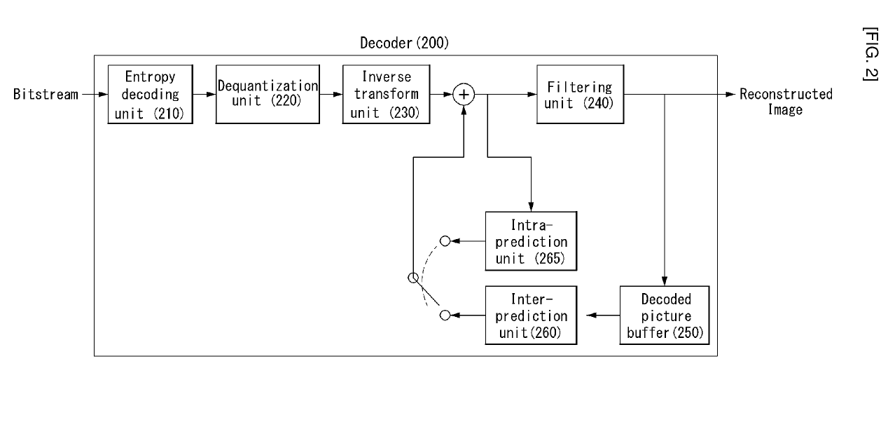

FIG. 2 shows a schematic block diagram of a decoder for decoding a video signal, in accordance with one embodiment of the present invention.

Referring to FIG. 2, a decoder 200 may include an entropy-decoding unit 210, a dequantization unit 220, an inverse transform unit 230, a filtering unit 240, a decoded picture buffer (DPB) 250, an inter-prediction unit 260 and an intra-prediction unit 265.

A reconstructed video signal output from the decoder 200 may be reproduced using a reproducing device.

The decoder 200 may receive the signal output from the encoder as shown in FIG. 1. The received signal may be entropy-decoded via the entropy-decoding unit 210.

The dequantization unit 220 may obtain a transform coefficient from the entropy-decoded signal using quantization step size information.

The inverse transform unit 230 may inverse-transform the transform coefficient to obtain a residual signal.

A reconstructed signal may be generated by adding the obtained residual signal to the prediction signal output from the inter-prediction unit 260 or the intra-prediction unit 265. In this case, the present invention provides various embodiments in which the inter-prediction unit 260 predicts motion information based on the correlation of motion information between a neighboring block and a current block.

The filtering unit 240 may apply filtering to the reconstructed signal and may output the filtered reconstructed signal to the reproducing device or the decoded picture buffer unit 250. The filtered signal transmitted to the decoded picture buffer unit 250 may be used as a reference picture in the inter-prediction unit 260.

Herein, detailed descriptions for the filtering unit 160, the inter-prediction unit 180 and the intra-prediction unit 185 of the encoder 100 may be equally applied to the filtering unit 240, the inter-prediction unit 260 and the intra-prediction unit 265 of the decoder 200 respectively.

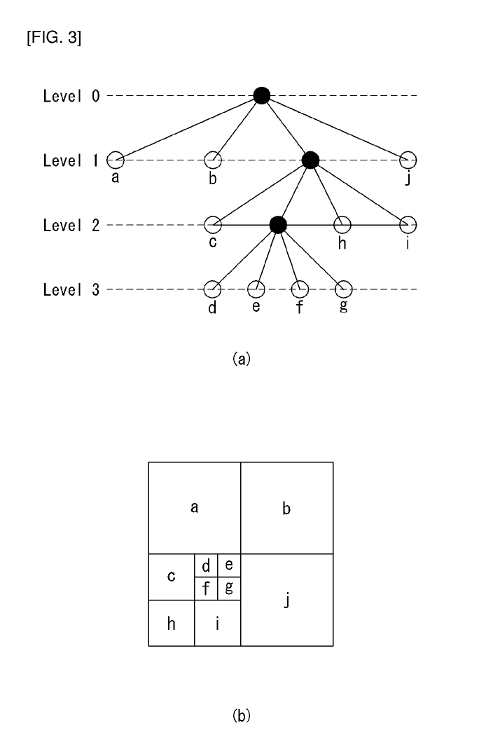

FIG. 3 is a view illustrating a partition structure of a coding unit according to an embodiment to which the present disclosure is applied.

An encoder may partition an image (or picture) by rectangular coding tree units (CTUs). Also, the encoder sequentially encodes the CTUs one after another in raster scan order.

For example, a size of the CTU may be determined to any one of 64×64, 32×32, and 16×16, but the present disclosure is not limited thereto. The encoder may selectively use a size of the CTU depending on resolution or characteristics of an input image. The CTU may include a coding tree block (CTB) regarding a luma component and a CTB regarding two chroma components corresponding thereto.

One CTU may be decomposed into a quadtree (QT) structure. For example, one CTU may be partitioned into four equal-sized square units and having each side whose length is halved each time. Decomposition according to the QT structure may be performed recursively.

Referring to FIG. 3, a root node of the QT may be related to the CTU. The QT may be divided until it reaches a leaf node, and here, the leaf node may be termed a coding unit (CU).

The CU may be a basic unit for coding based on which processing an input image, for example, intra/inter prediction is carried out. The CU may include a coding block (CB) regarding a luma component and a CB regarding two chroma components corresponding thereto. For example, a size of the CU may be determined to any one of 64×64, 32×32, 16×16, and 8×8, but the present disclosure is not limited thereto and the size of the CPU may be increased or diversified in the case of a high definition image.

Referring to FIG. 3, the CTU corresponds to a root node and has a smallest depth (i.e., level 0). The CTU may not be divided depending on characteristics of an input image and, in this case, the CTU corresponds to a CU.

The CTU may be decomposed into a QT form and, as a result, lower nodes having a depth of level 1 may be generated. A node (i.e., a leaf node) which is not partitioned any further, among the lower nodes having the depth of level 1, corresponds to a CU. For example, in FIG. 3(b), CU(a), CU(b), and CU(j) respectively corresponding to nodes a, b, and j have been once partitioned and have the depth of level 1.

At least one of the nodes having the depth of level 1 may be divided again into the QT form. Also, a node (i.e., a leaf node) which is not divided any further among the lower nodes having a depth of level 2 corresponds to a CU. For example, in FIG. 3(b), CU(c), CU(h), and CU(i) respectively corresponding to nodes c, h, and l have been divided twice and have the depth of level 2.

Also, at least one of the nodes having the depth of level 2 may be divided again in the QT form. Also, a node (leaf node) which is not divided any further among the lower nodes having a depth of level 3 corresponds to a CU. For example, in FIG. 3(b), CU(d), CU(e), CU(f), and CU(g) respectively corresponding to nodes d, e, f, and g have been divided three times and have the depth of level 3.

In the encoder, a largest size or a smallest size of a CPU may be determined according to characteristics (e.g., resolution) of a video image or in consideration of efficiency of coding. Also, information regarding the determined largest size or smallest size of the CU or information deriving the same may be included in a bit stream. A CPU having a largest size may be termed a largest coding unit (LCU) and a CU having a smallest size may be termed a smallest coding unit (SCU).

Also, the CU having a tree structure may be hierarchically divided with predetermined largest depth information (or largest level information). Also, each of the divided CUs may have depth information. Since the depth information represents the number by which a CU has been divided and/or a degree to which the CU has been divided, the depth information may include information regarding a size of the CU.

Since the LCU is divided into the QT form, a size of the SCU may be obtained using a size of the LCU and largest depth information. Or, conversely, a size of the LCU may be obtained using the size of the SCU and largest depth information of a tree.

Regarding one CU, information representing whether the corresponding CU is partitioned may be delivered to the decoder. For example, the information may be defined as a split flag and represented by a syntax element “split_cu_flag”. The split flag may be included in every CU except for the SCU. For example, if the value of the split flag is ‘1’, the corresponding CU is partitioned again into four CUs, while if the split flag is ‘0’, the corresponding CU is not partitioned further, but a coding process with respect to the corresponding CU may be carried out.

Although the embodiment of FIG. 3 has been described with respect to a partitioning process of a CU, the QT structure may also be applied to the transform unit (TU) which is a basic unit carrying out transformation.

A TU may be partitioned hierarchically into a quadtree structure from a CU to be coded. For example, the CU may correspond to a root node of a tree for the TU.

Since the TU may be partitioned into a QT structure, the TU partitioned from the CU may be partitioned into smaller TUs. For example, the size of the TU may be determined by any one of 32×32, 16×16, 8×8, and 4×4. However, the present invention is not limited thereto and, in the case of a high definition image, the TU size may be larger or diversified.

For each TU, information regarding whether the corresponding TU is partitioned may be delivered to the decoder. For example, the information may be defined as a split transform flag and represented as a syntax element “split_transform_flag”.

The split transform flag may be included in all of the TUs except for a TU having a smallest size. For example, when the value of the split transform flag is ‘1’, the corresponding CU is partitioned again into four TUs, and when the split transform flag is ‘0’, the corresponding TU is not partitioned further.

As described above, a CU is a basic coding unit, based on which intra- or inter-prediction is carried out. In order to more effectively code an input image, a CU can be decomposed into prediction units (PUs).

A PU is a basic unit for generating a prediction block; prediction blocks may be generated differently in units of PUs even within one CU. A PU may be partitioned differently according to whether an intra-prediction mode or an inter-prediction mode is used as a coding mode of the CU to which the PU belongs.

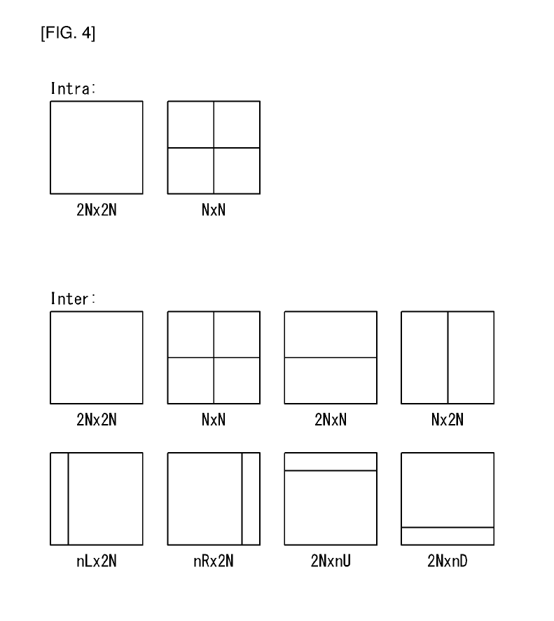

FIG. 4 is a view illustrating a prediction unit according to an embodiment to which the present disclosure is applied.

A PU is partitioned differently depending only whether an intra-prediction mode is used or inter-prediction mode is used as a coding mode of a CU to which the PU belongs.

FIG. 4(a) illustrates a PU when the intra-prediction mode is used and FIG. 4(b) illustrates a PU when the inter-prediction mode is used.

Referring to FIG. 4(a), when it is assumed that a size of a CU is 2N×2N(N=4, 8, 16, 32), one CU may be partitioned into two types (i.e., 2N×2N [symbol] N×N).

Here, when a CU is partitioned into PUs in the form of 2N×2N, it means that only one PU is present within one CU.

Meanwhile, when a CU is partitioned into PUs in the form of N×N, one CU is partitioned into four Pus and different prediction blocks are generated for each PU unit. However, partitioning the PU may be performed only when a size of a CB regarding a luma component of the CU is a smallest size (i.e., when the CU is an SCU).

Referring to FIG. 4(b), when a case in which a size of one CU is 2N×2N (N=4, 8, 16, 32) is assumed, one CU may be partitioned into eight PU types (i.e., 2N×2N, N×N, 2N×N, N×2N, nL×2N, nR×2N, 2N×nU, 2N×nD).

Similar to intra-prediction, the PU partition in the form of N×N may be carried out only when a size of a CB regarding a luma component of a CU is a smallest size (that is, when a CU is an SCU).

In the inter-prediction, PU partitioning in the form of 2N×N in which a PU is partitioned in a transverse direction and in the form of N×2N in which a PU is partition in a longitudinal direction are supported.

Also, PU partitioning in the form of nL×2N, nR×2N, 2N×nU, and 2N×nD as asymmetric motion partitioning (AMP) is supported. Here, “n” refers to ¼ of 2N. However, AMP may not be used in cases where a CU to which a PU belongs is a CU having a smallest size.

In order to effectively code an input image of one CTU, an optimal partitioning structure of a coding unit (CU), a prediction unit (PU), and a transform unit (TU) may be determined based on a minimum rate-distortion) value through the following process. For example, as for a process of an optimal CU partitioning within 64×64 CTU, rate-distortion cost, while performing a partitioning process from a CU having a size of 64×64 to a CU having a size of 8×8, may be calculated. Details thereof are as follows.

1) Inter/intra prediction, transform/quantization, inverse quantization/inverse transform, and entropy encoding are performed on a CU having a size of 64×64 to determine an optimal partitioning structure of a PU and a TU generating a minimum rate-distortion value.

2) A 64×64 CU is partitioned to four CUs having a size of 32×32, and an optimal partitioning structure of a PU and a TU generating a minimum rate-distortion value is determined for each 32×32 cu.

3) The 32×32 CU is partitioned again to four CUs having a size of 16×16, and an optimal partitioning structure of a PU and a TU generating a minimum rate-distortion value is determined for each 16×16 CU.

4) The 16×16 CU is partitioned again to four CUs having a size of 8×8, and an optimal partitioning structure of a PU and a TU generating a minimum rate-distortion value is determined for each 8×8 CU.

5) An optimal CU partitioning structure within the 16×16 block is determined by comparing the sum of the rate-distortion value of 16×16 CU calculated in the process of 3) and the rate-distortion values of four 8×8 CUs calculated in the process of 4). This process is also performed on the other three 16×16 CUs in the same manner.

6) An optimal CU partitioning structure within the 32×32 block is determined by comparing the sum of the rate-distortion value of 32×32 CU calculated in the process of 2) and the rate-distortion values of four 16×16 CUs obtained in the process of 5). This process is also performed on the other three 32×32 CUs in the same manner.

7) Finally, an optimal CU partitioning structure within the 64×64 block is determined by comparing the sum of the rate-distortion value of 64×64 CUs calculated in the process of 1) and the rate-distortion values of four 32×32 CUs obtained in the process of 6).

In the intra-prediction mode, a prediction mode is selected in units of PUs, and prediction and reconstruction is carried out in actual units of TUs on the selected prediction mode.

The TU refers to a basic unit by which actual prediction and reconstruction are carried out. The TU includes a transform block (TB) regarding a luma component and a TB regarding two chroma components corresponding thereto.

In the foregoing example of FIG. 3, like one CTU is partitioned into a QT structure to generate CUs, a TU is hierarchically partitioned into a QT structure from one CU.

Since the TU is partitioned to a QT structure, the TU partitioned from a CU may be partitioned into smaller TUs again. In HEVC, a size of a TU may be determined to any one of 32×32, 16×16, 8×8, 4×4.

Referring back to FIG. 3, it is assumed that a root node of a QT is related to a CU. A QT is partitioned until it reaches a leaf node, and the leaf node corresponds to a TU.

In detail, a CU corresponds to a root node and has a smallest depth (i.e., depth=0). The CU may not be partitioned according to characteristics of an input image, and in this case, the CU corresponds to a TU.

The CU may be partitioned to a QT form, and as a result, lower nodes having a depth of 1 (depth=1) are generated. Among the lower nodes having the depth of 1, a node which is not partitioned any further (i.e., a leaf node) corresponds to a TU. For example, in FIG. 3(b), TU(a), TU(b), and TU(j) respectively corresponding to a, b, and j have been once partitioned from a CU and have a depth of 1.

At least any one of nodes having the depth of 1 may also be partitioned to a QT form, and as a result, lower nodes having a depth of 2 (i.e., depth=2) are generated. Among the lower nodes having the depth of 2, a node which is not partitioned any further (i.e., a lead node) corresponds to a TU. For example, in FIG. 3(b), TU(c), TU(h), and TU(i) respectively corresponding to c, h, and l have been partitioned twice from a CU and have the depth of 2.

Also, at least one of nodes having the depth of 2 may be partitioned again to a QT form, and as a result, lower nodes having a depth of 3 (i.e., depth=3) are generated. Among the lower nodes having the depth of 3, a node which is not partitioned any further (i.e., a leaf node) corresponds to a CU. For example, in FIG. 3(b), TU(d), TU(e), TU(f), and TU(g) respectively corresponding to nodes d, e, f, and g have been partitioned three times and have the depth of 3.

The TU having a tree structure may be hierarchically partitioned with predetermined largest depth information (or largest level information). Also, each of the partitioned TUs may have depth information. Since depth information represents the number by which the TU has been partitioned and/or a degree to which the TU has been divided, the depth information may include information regarding a size of the TU.

Regarding one TU, information (e.g., a split TU flag (split_tranform_flag) representing whether the corresponding TU is partitioned may be delivered to the decoder. The split information is included in every TU except for a TU having a smallest size. For example, if the value of the flag representing partition is ‘1’, the corresponding TU is partitioned again into four TUs, while if the flag representing partition is ‘0’, the corresponding CU is not partitioned any further.

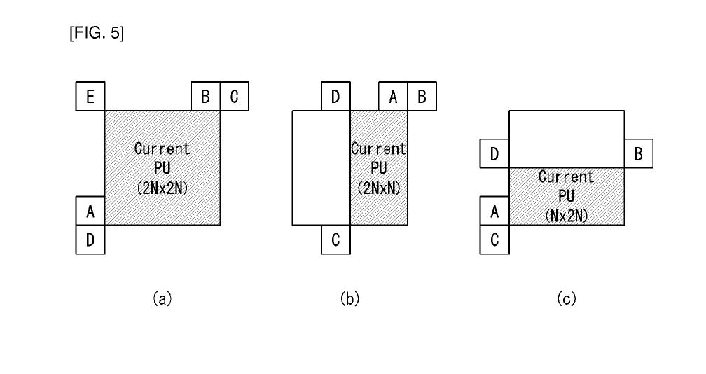

FIG. 5 is a view illustrating a method for deriving motion information using spatial correlation according to an embodiment to which the present disclosure is applied.

In video signal coding, inter-prediction allows for predicting a current block using temporal correlation. The current block makes a prediction by using at least one previously encoded frame as a reference. The inter-prediction may be done for an asymmetrically-shaped prediction block as well as for a square block. According to the inter-prediction, the encoder may send a reference index, motion information, and a residual signal to the decoder. In this case, a merge mode does not send motion information of a current prediction block, but derives motion information of the current prediction block by using motion information of a neighboring prediction block. Thus, motion information of the current prediction block may be derived by sending flag information indicating the use of the merge mode and a merge index indicating which neighboring prediction block is used.

In order to perform the merge mode, the encoder needs to search for a merge candidate block which is used to derive motion information of the current prediction block. For example, up to five merge candidate blocks may be used, but the present invention is not limited thereto. Also, the maximum number of merge candidate blocks may be sent in a slice header, and the present invention is not limited to this. After searching the merge candidate blocks, the encoder may create a merge list and select the merge candidate block with the lowest cost as a final merge candidate block.

The present invention provides various embodiments for merge candidate blocks that make up the merge list.

The merge list may use five merge candidate blocks, for example, four spatial merge candidates and one temporal merge candidate. In a specific example, the blocks shown in (a) to (c) of FIG. 5 may be used as spatial merge candidates.

(a) of FIG. 5 depicts the positions of spatial merge candidates for a 2N×2N current prediction block. For example, the encoder may search the five blocks shown in (a) of FIG. 5 in the order: A, B, C, D, and E, and make a merge list out of four of them.

(b) of FIG. 5 depicts the positions of spatial merge candidates for a current candidate block with a size of 2N×N and located on the right side. For example, the encoder may search the four blocks shown in (b) of FIG. 5 in the order: A, B, C, and D, and make a merge list.

(c) of FIG. 5 depicts the positions of spatial merge candidates for a current candidate block with a size of N×2N and located on the lower side. For example, the encoder may search the four blocks shown in (c) of FIG. 5 in the order: A, B, C, and D, and make a merge list. Meanwhile, spatial merge candidates having redundant motion information may be removed from the merge list.

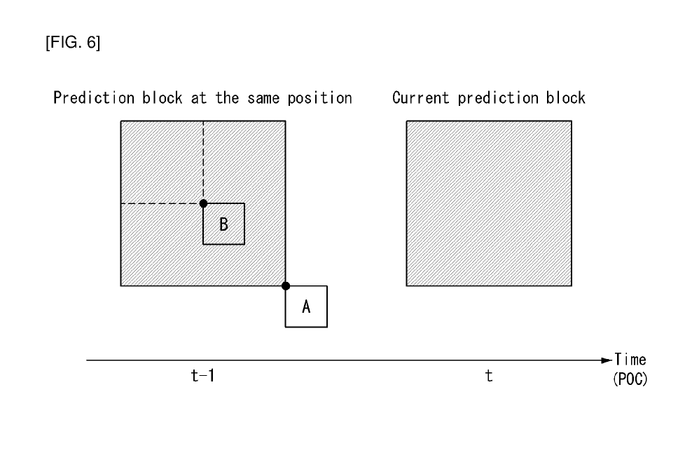

FIG. 6 is a view illustrating a method for deriving motion information using temporal correlation according to an embodiment to which the present disclosure is applied.

The merge list may be made out of temporal merge candidates first, as described with reference to FIG. 5, and then out of a temporal merge candidate.

The present invention provides various embodiments for temporal merge candidates that make up the merge list.

Referring to FIG. 6, a prediction block within a frame different from a current frame, having the same position with a current prediction block, may be used as a temporal merge candidate. For example, the encoder may search the blocks shown in FIG. 6 in the order: A and B, and make a merge list. Here, the different frame may be a frame previous or subsequent to the current frame on the picture order count (POC).

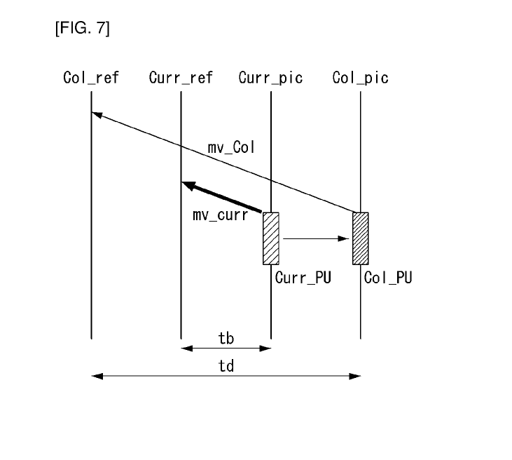

FIG. 7 is a view illustrating a method for scaling a motion vector based on temporal correlation according to an embodiment to which the present disclosure is applied.

After temporal merge candidates are configured as described with reference to FIG. 6, motion vector scaling may be needed.

Referring to FIG. 7, a current picture is denoted by Curr_pic, a reference picture for the current picture is denoted by Curr_ref, a collocated picture is denoted by Col_pic, a reference picture for the collocated picture is denoted by Col_ref, the motion vector of a current prediction block is denoted by mv_curr, and the motion vector of the collocated picture is denoted by mv_Col. Here, the collocated picture refers to a picture collocated with the current picture—for example, a reference picture contained in Reference Picture List 0 or Reference Picture List 1, or a picture including a temporal merge candidate.

In this case, if the reference picture for the current picture and a reference picture for the temporal merge candidate are different, the motion pictures may be scaled in proportion to a temporal distance. For example, when the temporal distance between the current picture and the reference picture is denoted by tb, and the temporal distance between the collocated picture and the reference picture for the collocated picture is td, the motion vector mv_Col of the collocated picture may be scaled according to a distance ratio between tb and td, thereby obtaining the motion vector mv_curr of the current prediction block.

Meanwhile, if the merge list is not full, a new merge candidate for bidirectional prediction may be created by combining the currently added candidates, or a zero motion vector may be added.

The encoder may select the candidate block with the lowest cost by calculating the cost for each of the candidate blocks in the thusly-created merge list.

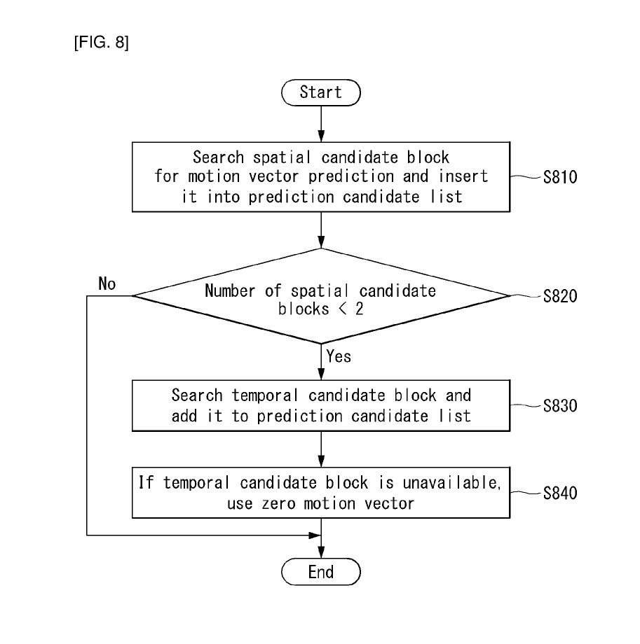

FIG. 8 is a flowchart illustrating a method for deriving a motion vector prediction value from a neighboring block according to an embodiment to which the present disclosure is applied.

In a motion vector prediction mode to which the present invention is applied, the encoder predicts the motion vector of a prediction block according to its type and sends the difference between an optimal motion vector and a prediction value to the decoder. In this case, the encoder sends a motion vector difference value, neighboring block information, a reference index, etc. to the decoder.

The encoder may create a prediction candidate list for motion vector prediction, and the prediction candidate list may include at least one between a spatial candidate block and a temporal candidate block.

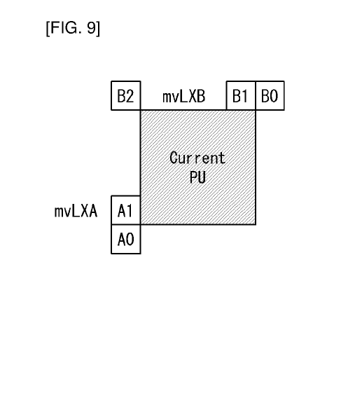

First of all, the encoder may search a spatial candidate block for motion vector prediction and insert it into the prediction candidate list (S810). A spatial candidate block may be found by the method explained with reference to FIG. 5, which will be described specifically with reference to FIG. 9.

The encoder may check whether the number of spatial candidate blocks is less than two (S820).

If the result of the check shows that the number of spatial candidate blocks is less than two, the encoder may search a temporal candidate block and add it to the prediction candidate list (S830). If the temporal candidate block is unavailable, the encoder may use a zero motion vector as a motion vector prediction value (S840).

The process of configuring a temporal candidate block may be done by the method explained with reference to FIG. 6, and the process of scaling the motion vector of a temporal candidate block may be done by the method explained with reference to FIG. 7.

Meanwhile, if the result of the check shows that the number of spatial candidate blocks is two or more, the encoder may finish configuring the prediction candidate list and select the candidate block with the lowest cost. The motion vector of the selected candidate block may be determined as a motion vector prediction value of the current block, and the motion vector difference value may be obtained by using the motion vector prediction value. The thusly-obtained motion vector difference value may be sent to the decoder.

FIG. 9 is a view illustrating a spatial candidate block for deriving a motion vector prediction value according to an embodiment to which the present disclosure is applied.

As for the motion vector prediction mode to which the present invention is applied, a method of searching a spatial candidate block for making up a prediction candidate list will be described. A method of searching a spatial candidate block for predicting a motion vector may be the same as for the positions of spatial candidate blocks explained with reference to FIG. 5, but in a different sequence.

For example, one among A, A0, scaled A, and scaled A0 and one among B0, B1, B2, scaled B1, and scaled B2 are selected and used as two spatial candidate blocks, and the motion vectors of the selected two spatial candidate blocks may be set to mvLXA and mvLXB.

In the motion vector prediction mode, the motion vector of one of a plurality of neighboring blocks is used as a motion vector prediction value, and flag information indicating the position of the block used and a motion vector difference value may be sent to the decoder. In the motion vector prediction mode, up to two of spatial candidate blocks and temporal candidate blocks may be used.

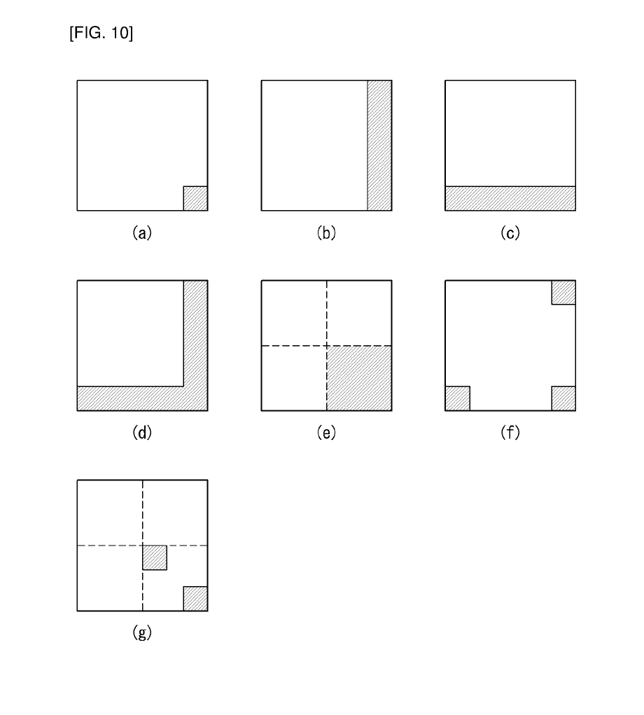

FIG. 10 is a view illustrating a temporal candidate block for deriving a motion vector prediction value from within a collocated block according to an embodiment to which the present disclosure is applied.

Temporal Motion Vector Prediction Based on Blocks Around Right Bottom (Hereinafter, “TMVP”)

TMVP may mean the addition of other candidate blocks that cannot be obtained from spatial candidate blocks—for example, temporal candidate blocks.

Also, TMVP may involve the addition of a block in a right bottom area as a candidate block for predicting motion information because spatial candidate blocks are dominant on the left top. However, in the case of a current picture or current block, the right bottom area is not reconstructed yet and therefore unavailable. Thus, motion information of the blocks in the right bottom area can be used by using a collocated block (hereinafter, “colPb”) of a collocated picture (hereafter, “colPic”). For example, the colPb may be defined as a block corresponding to the position of a current prediction unit (current PU) in the current picture. This definition may be applied to descriptions of other embodiments in this specification.

In an embodiment to which the present invention is applied, TMVP-related information may be obtained from information that exists in at least one between within and outside colPb. For example, TMVP-related information may be obtained from information that exists within colPb, information that exists outside colPb, or a combination of information that exists within and outside colPb. Here, the TMVP-related information may include a motion vector prediction value. Alternatively, the TMVP-related information may further include at least one of a motion vector difference value, a motion vector prediction mode, or block position-related information.

Referring to FIG. 10, a temporal candidate block for deriving a motion vector prediction value from within colPb may be determined.

For example, TMVP-related information may be obtained from motion information of a block on the right bottom, as in (a) of FIG. 10, or TMVP-related information may be obtained from motion information of at least one of blocks on the right boundary, as in (b) of FIG. 10.

Alternatively, TMVP-related information may be obtained from motion information of at least one of blocks on the bottom boundary, as in (c) of FIG. 10, or TMVP-related information may be obtained from motion information of at least one of blocks on the right and bottom boundaries, as in (d) of FIG. 10.

Alternatively, TMVP-related information may be obtained from motion information of at least one of blocks in the right bottom quarter within colPb, as in (e) of FIG. 10, or TMVP-related information may be obtained from motion information of blocks in predetermined specific candidate areas, as in (f) and (g) of FIG. 10. The candidate areas shown in (f) and (g) of FIG. 10 are only examples, and the specific candidate areas within coLPB may be arbitrarily selected.

Alternatively, TMVP-related information may be obtained by a selective combination of the examples of (a) to (g) of FIG. 10.

Moreover, the positions described in the examples of (a) to (g) of FIG. 10 indicate adjacent blocks within colPb, but the present invention is not limited thereto and they may indicate non-adjacent blocks at arbitrary positions within colPb.

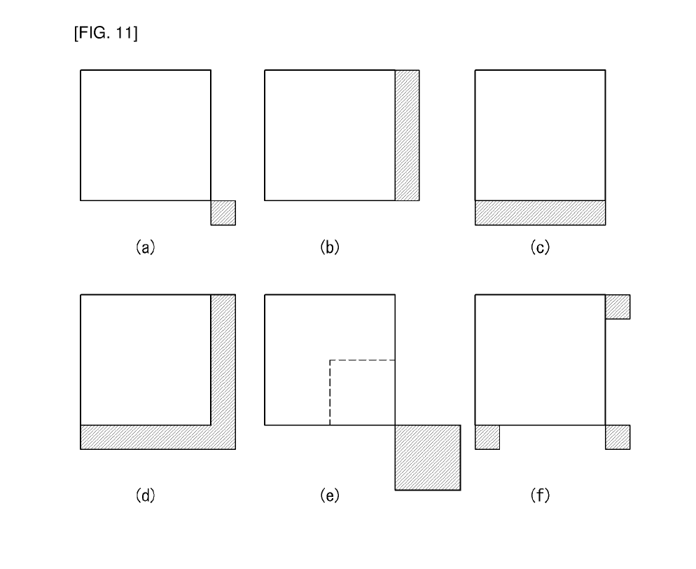

FIG. 11 is a view illustrating a temporal candidate block for deriving a motion vector prediction value from outside a collocated block according to an embodiment to which the present disclosure is applied.

Referring to FIG. 11, a temporal candidate block for deriving a motion vector prediction value from outside colPb may be determined. Here, the “outside colPb” may involve at least one among blocks on the right, bottom, and right bottom, which are adjacent to colPB. However, the present invention is not limited to this, and “outside colPb” may involve other blocks within a picture or frame containing colPb.

For example, TMVP-related information may be obtained from motion information of an adjacent block on the right bottom outside colPb, as in (a) of FIG. 11, or TMVP-related information may be obtained from motion information of at least one of adjacent blocks on the right boundary outside colPb, as in (b) of FIG. 11.

Alternatively, TMVP-related information may be obtained from motion information of at least one of adjacent blocks on the bottom boundary outside colPb, as in (c) of FIG. 11, or TMVP-related information may be obtained from motion information of at least one of adjacent blocks on the right and bottom boundaries outside colPb, as in (d) of FIG. 11.

Alternatively, TMVP-related information may be obtained from motion information of at least one of adjacent blocks in the right bottom quarter outside colPb, as in (e) of FIG. 11, or TMVP-related information may be obtained from motion information of adjacent blocks in predetermined specific candidate areas outside colPb, as in (f) of FIG. 11. The candidate areas shown in (f) of FIG. 11 are only an example, and the adjacent specific candidate areas outside coLPB may be arbitrarily selected.

Alternatively, TMVP-related information may be obtained by a selective combination of the embodiments of (a) to (f) of FIG. 11.

Moreover, the positions described in the embodiments of (a) to (f) of FIG. 11 indicate adjacent blocks outside colPb, but the present invention is not limited thereto and they may indicate non-adjacent blocks at arbitrary positions outside colPb.

In other embodiments to which the present invention is applied, TMVP-related information may be obtained from a combination of information that exists internally or externally.

In this case, TMVP-related information may be obtained first based on external information of colPb, and if external information is unavailable, internal information may be used. Alternatively, TMVP-related information may be obtained first based on internal information of colPb, and if internal information is unavailable, external information may be used.

In other embodiments to which the present invention is applied, a candidate block or candidate area for obtaining TMVP-related information may include at least one among a motion vector, a reference index, and mode-related information.

The encoder may select at least one piece of the above information and use it as TMVP-related information. Alternatively, the encoder may select multiple pieces of information and use new information created from a combination thereof as TMVP-related information.

In this instance, the encoder may select at least one piece of the above information according to a predetermined rule. For example, a rule can be set up in advance to select one or more of the candidate blocks of FIG. 10 and the candidate blocks of FIG. 11 first of all and then select other candidate blocks if the selected blocks are unavailable.

In other embodiments to which the present invention is applied, at least one piece of the above information may be selected through signaling.

For example, when there are multiple candidate blocks or candidate areas for obtaining TMVP-related information, a 1-bit flag or an index defined by several bits may be sent to select a specific candidate.

In a specific example, when a single candidate is obtained from the right bottom outside colPb and a single candidate is obtained from the right bottom within colPb, a 1-bit flag may be sent to determine one between the two.

Meanwhile, when there is only one candidate block or candidate area for obtaining TMVP-related information, the above information may not be signaled.

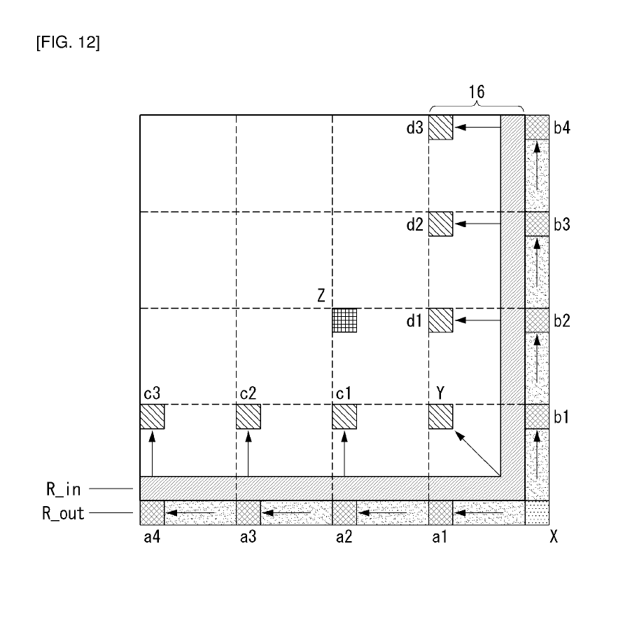

FIG. 12 is a view illustrating a change in the areas of temporal candidate blocks for deriving a motion vector prediction value from within/outside a collocated block in a case where motion information of a reference picture is compressed, according to an embodiment to which the present disclosure is applied.

In a case where motion information of a reference picture is compressed, candidate blocks within/outside colPb for obtaining TMVP information may be separated. Even when trying to obtain internal/external motion information around the right bottom of colPb depending on the size of a prediction block, motion information may be obtained from the left top or a position adjacent to a candidate block for the motion information prediction mode/merge mode, due to motion information compression.

Accordingly, in order to use motion information based on a block on the right bottom as TMVP information, in the present invention, TMVP information may be obtained from outside a CU to which colPB belongs. For example, the blocks shown in FIG. 12 may be a 64×64 CU containing colPb, and, in the present invention, TMVP information may be obtained from an R_out area.

In another embodiment, TMVP information may be obtained with reference to the availability of spatial candidates for the motion vector prediction mode and merge mode.

In another embodiment, TMVP information may be obtained based on a distance between a specific reference point and candidates from which TMVP information can be obtained, considering the form of colPb or the form of the CU to which colPb belongs. For example, when the blocks shown in FIG. 12 represent colPb, an external block X on the right bottom may be determined as a highest-priority candidate block. If the block X is unavailable, TMVP information may be obtained from a block Z on the right bottom of the center.

In another embodiment, TMVP-related information may be obtained by a selective combination of the above embodiments.

For example, when the blocks shown in FIG. 12 represent colPb, TMVP information may be obtained from the R_out area outside colPb after the availability of each block is checked in the order: blocks X, a1, a2, a3, and a4 or in the order: blocks X, b1, b2, b3, and b4.

In another example, when the blocks shown in FIG. 12 represent colPb, TMVP information may be obtained from an R_in area within colPb. If the R_in area is unavailable, TMVP information may be obtained from blocks Y, c1, c2, c3, d1, d2, and d3.

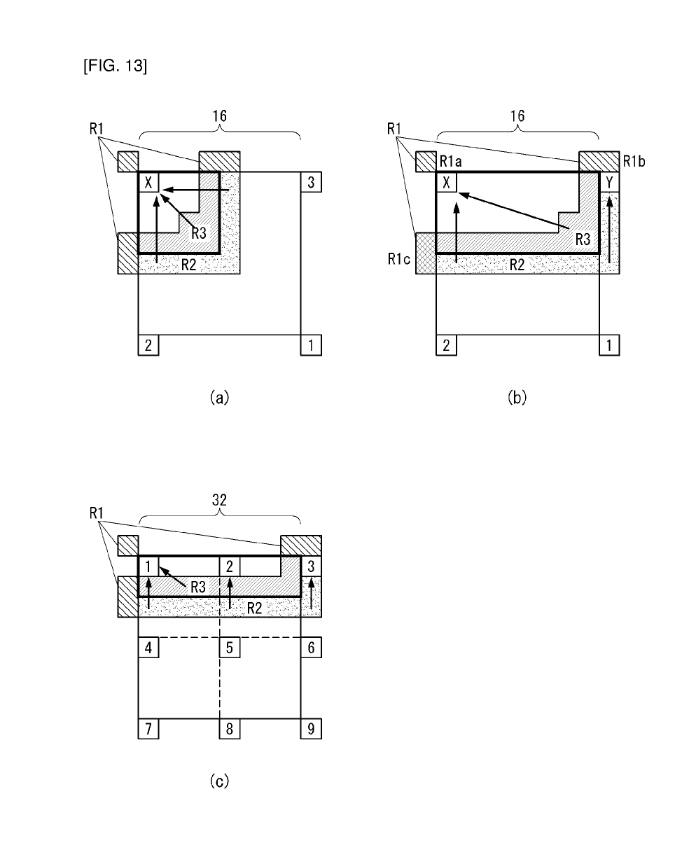

FIG. 13 is a method for selecting a temporal candidate block for deriving a motion vector prediction value from within/outside a collocated block in a case where motion information of a reference picture is compressed, according to an embodiment to which the present disclosure is applied.

Referring to (a) of FIG. 13, in a case where colPb (thick solid line) is 8×8 and motion information is compressed to a size of 16×16, TMVP information derived from either of candidate areas R2 and R3 within and outside the right bottom of colPb is the same as the information derived from the block X on the left top. In this case, TMVP information is derived from a position adjacent to an R1 candidate area, so the same or similar motion information may be obtained. Here, the R1 candidate area may refer to a candidate area for the motion information prediction mode or merge mode.

Accordingly, in the present invention, TMVP information may be obtained from at least one of candidate areas 1, 2, and 3 outside a CU (thin solid line) containing colPb.

Referring to FIG. (b) of FIG. 13, in a case where colPb (thick solid line) is 16×8 and motion information is compressed to a size of 16×16, TMVP information derived from either of candidate areas R2 or R3 within and outside the right bottom of colPb is the same as the information derived from the blocks X and Y. For example, in the present invention, if R1a and R1b candidate areas of the R1 candidate area are available but an R2 candidate area thereof is not available, TMVP information may be obtained from at least one of candidate areas 1 and 2. As such, TMVP information that is not the same as or similar to motion information in the R1 candidate area may be obtained.

Referring to (c) of FIG. 13, in the present invention, in a case where colPb (thick solid line) is 32×8 and motion information is compressed to a size of 16×16, motion information for TMVP may be derived from at least one of candidate areas 1 to 9.

In this case, when the right bottom boundary is used as a reference point, TMVP information may be obtained from the candidate areas 3 and 6 since they are the closest in distance.

In another example, when the right bottom boundary is used as a reference point but excludes any area adjacent to the candidate area for the motion information prediction mode or merge mode as in (a) of FIG. 13, TMVP information may be obtained from the candidate area 6.

In another example, when the left top boundary is used as a reference point, TMVP information may be obtained from the candidate area 1 since it is the closest in distance.

In another example, when the left top boundary is used as a reference point but excludes any area adjacent to the candidate area for the motion information prediction mode or merge mode as in (a) of FIG. 13, TMVP information may be obtained from the closest candidate areas 2 and 4, apart from the candidate area 1. Alternatively, seeing both the candidate areas 2 and 4 as an extension of the candidate area for the motion information prediction mode or merge mode, TMVP information may be obtained from the next closest candidate area 5.

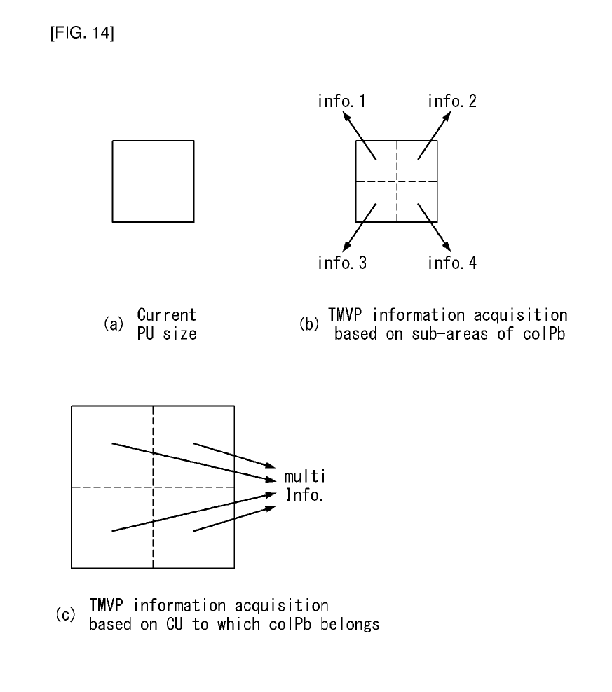

FIG. 14 is a view illustrating a method for obtaining motion information from an arbitrary area within a collocated prediction block according to an embodiment to which the present disclosure is applied.

TMVP Refinement

colPb represents a collocated prediction block, and colPic represents a picture containing the colPb. An arbitrary picture that exists in a reference picture list may be designated as the colPic by the syntax of the slice level. However, determining colPic at the slice level has the problem that, even if there is any colPic with a more optimal colPb for a corresponding individual prediction unit, it cannot be actually selected. Accordingly, the present invention intends to solve this problem by changing the unit of determination of colPic.

In one embodiment of the present invention, colPic may be determined for each arbitrary area in order to find the optimal colPic. For example, the arbitrary area may be smaller than, equal to, or larger than a slice. Also, the arbitrary area may be defined at the level of at least one of the following: an entire sequence, one or more GOPs (group of pictures), one or more frames, one or more fields, one or more slices, one or more LCUs, one or more CUs, one or more PUs, and one or more minimum motion blocks. Here, the minimum motion blocks may refer to blocks of the smallest size that may have motion information.

Moreover, in another embodiment of the present invention, colPic may be determined for each prediction unit or for each minimum motion block.

In another embodiment, colPic may be determined by a selective combination of the areas listed above.

In another embodiment of the present invention, information indicating the optimal colPic may be obtained separately through signaling. Alternatively, this information may be selected from among the reference indices of AMVP candidates or the reference indices of merge candidates. Also, this information may be selected from among the reference indices of neighboring arbitrary blocks that are not the AMVP/merge candidates, or may be selected by a selective combination of the methods listed above.

For example, in the present invention, an optimal collocated picture may be determined based on the reference index of at least one among an AMVP (advanced motion vector predictor) candidate block, a merge candidate blocks, and a neighboring block with respect to the current block, and motion information TMVP of the current block may be predicted based on information of a collocated block within the optimal collocated picture. Also, a prediction signal may be generated based on the predicted motion information.

In another embodiment of the present invention, TMVP-related information may be obtained for each arbitrary area. For example, the arbitrary area may be an area that is smaller in size than the current prediction unit of (a) of FIG. 14. The end results to be obtained through colPb subject to TMVP are the reference index and motion information of a corresponding block. Thus, once colPic and colPb are determined, a more detailed motion compensation block may be created when retrieving TMVP information than when retrieving multiple pieces of motion information from areas smaller than the size of the current prediction unit, and, as a result, this will help improve performance.

Moreover, the arbitrary area may be equal to or larger than the size of the current prediction unit. Also, the arbitrary area may be defined at the level of at least one of the following: an entire sequence, one or more GOPs (group of pictures), one or more frames, one or more fields, one or more slices, one or more LCUs, one or more CUs, one or more PUs, and one or more minimum motion blocks. Here, the minimum motion blocks may refer to blocks of the smallest size that may have motion information.

In another embodiment, colPic may be determined by a selective combination of the areas listed above.

Referring to (b) of FIG. 14, colPb may be divided into four sub-areas, and motion compensation may be performed on each sub-area by using information (info.1, info.2, info.3, and info.4) contained in the respective sub-areas.

Referring to (c) of FIG. 14, motion compensation may be performed on the current prediction unit by using information (multi info.) contained in a coding unit area to which colPb belongs.

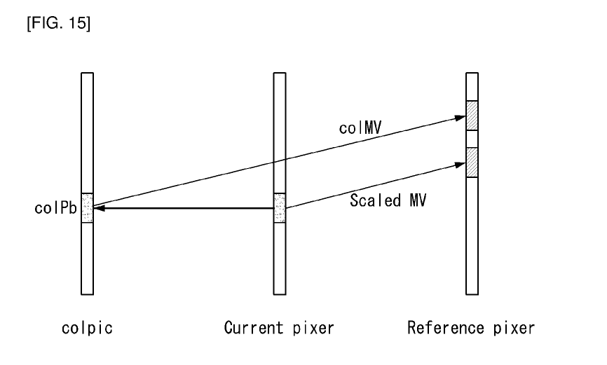

FIG. 15 is a view illustrating a method for scaling the motion vector of a temporal candidate block according to an embodiment to which the present disclosure is applied.

In the present invention, in obtaining TMVP-related motion information, the motion information may be scaled in order to compensate for a distance difference between colPic and the current picture. However, the present invention is not limited to this and motion information may be used without scaling, or a selective combination of the two may be used.

Referring to FIG. 15, the motion vector of colPB within colPic may be denoted by colMV, and the motion vector of the current picture may be denoted by scaled MV, which is obtained by scaling the colMV. In this instance, the scaling factor may be set to a ratio between a first temporal distance between the current picture and a reference picture and a second temporal distance between colPic and the reference picture.

In another embodiment to which the present invention is applied, a method of compressing and storing motion information of a reference picture may be used. In terms of memory saving, motion information compensation may have the advantage of reducing the amount of motion information of reference pictures stored in a decoded picture buffer DP. However, when performing motion compensation on motion information obtained from an area smaller than the size of a prediction unit, the TMVP information acquisition methods to be explained in this specification may be more efficient unless motion information compensation is not used.

Hereinafter, the methods for obtaining TMVP information according to an embodiment to which the present invention is applied will be described.

First, TMVP information may be obtained always based on compressed motion information, regardless of whether the motion information is compressed or not.

Second, TMVP information may be obtained from uncompressed, available motion information if motion information compression is not used, or TMVP information may be obtained based on compressed motion information if the motion information is compressed.

Third, regardless of whether the motion information is compressed or not, it is possible to define information about whether TMVP information will be obtained based on uncompressed motion information or compressed motion information,

Fourth, using a neighboring block as a reference, it is possible to derive information about whether TMVP information will be obtained based on compressed motion information or uncompressed motion information.

Fifth, TMVP information may be obtained by a selective combination of the above methods.

In another embodiment to which the present invention is applied, because motion information compression may affect TMVP performance, whether to compress motion information or not may be determined as follows. For example, whether to compress motion information or not may be signaled at the level of at least one of an SPS (sequence parameter set), a PPS (picture parameter set), an APS (adaptation parameter set), and a slice header.

Moreover, whether to compress motion information may not be signaled separately, but may be derived from reference picture-related information such as a temporal layer ID, an RPS (reference picture set), and a DPB (decoded picture buffer). Alternatively, a selective combination of the above methods may be used.

In an embodiment to which the present invention is applied, whether to perform motion information compression may be defined hierarchically by using a flag. For example, whether to perform motion information compression at a lower level may be determined by defining the flag at an upper level. In a specific example, an upper-level parameter set such as an SPS (sequence parameter set) or a PPS (picture parameter set) may define a flag indicating whether to perform motion information compression in a lower-level parameter set. According to the flag, the slice header may signal or not about whether to perform motion information compression on a corresponding slice.

In an embodiment to which the present invention is applied, a picture with a low temporal layer ID is coded at higher quality compared to a picture with a high temporal layer ID. Thus, it is better not to compress motion information to help obtain TMVP that can increase the accuracy of a prediction block. Accordingly, motion information compression is performed on a picture with a high temporal layer ID but not on a picture with a low temporal layer ID. A temporal layer ID for determining whether to perform motion information compression may be fixed or hierarchically defined by a flag.

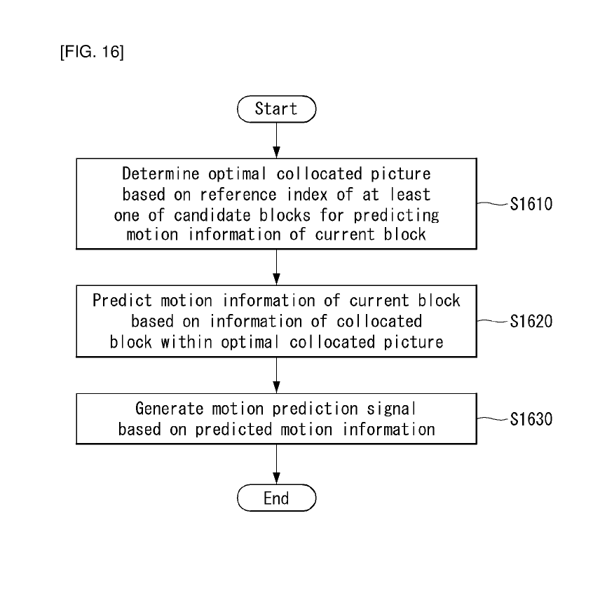

FIG. 16 is a flowchart illustrating a method for predicting motion information from an optimal candidate area according to an embodiment to which the present invention is applied.

An optimal collocated picture may be determined based on the reference index of at least one of candidate blocks for predicting motion information of a current block (S1610). For example, the candidate blocks for predicting motion information may include at least one among an AMVP (advanced motion vector predictor) candidate block, a merge candidate block, and a neighboring block with respect to the current block.

Motion information of the current block may be predicted based on information of a collocated block within the optimal collocated picture (S1620). The information of the collocated block may be obtained from an area that is set with respect to the right bottom of the collocated block. For example, the information of the collocated block may include at least one between internal and external information of the collocated block.

Here, the internal information may include at least one of the following: a right bottom corner area; a right boundary area; a bottom boundary area; a right bottom quarter area; a right top corner area; a left bottom corner area; a center area; a preset specific area; or a combination thereof, which exist within the collocated block. The external information may include at least one of the following: a right bottom corner area; a right boundary area; a bottom boundary area; a right bottom quarter area; a right top corner area; a left bottom corner area, a center area of the block on the right bottom; a preset specific area; or a combination thereof, which exist within the area of the blocks on the right, bottom, and right bottom adjacent to the collocated block and are adjacent to the collocated block.

Moreover, in a case where motion information of the optimal collocated picture is compressed, the motion information of the current block may be predicted from an external area of a coding unit containing the collocated block. The external area may include at least one of the following: a right top corner area, a right bottom corner area, a left bottom corner area, or a combination thereof, which are adjacent to the coding unit.

In addition, in a case where motion information of the optimal collocated picture is compressed, the motion information of the current block may be predicted based on a distance between a specific position and a candidate area. The specific position may be preset based on the form of the collocated block or the form of a coding unit containing the collocated block. For example, if the collocated block is in the form of 2N×nU and motion information of the optimal collocated picture is compressed to a size of N×N, the specific position may be the right bottom boundary or the left top boundary.

Meanwhile, whether motion information of the optimal collocated picture is compressed or not may be defined by a flag, and the decoder may receive the flag. In this case, the flag may be received from at least one among a sequence parameter set, a picture parameter set, an adaptation parameter set, and a slice header.

Furthermore, the information of the collocated block may be scaled by considering the temporal distance between the current picture containing the current block and the optimal collocated picture.

As seen from above, a motion prediction signal may be generated based on predicted motion information (S1630). A motion vector may be obtained by adding the thusly-generated motion prediction signal and a transmitted motion vector difference value, and a prediction signal may be generated by performing motion compensation based on the motion vector. A video signal may be restored by adding the prediction signal and a residual signal.

As described above, the embodiments explained in the present invention may be implemented and performed on a processor, a microprocessor, a controller or a chip. For example, functional modules explained in FIG. 1 and FIG. 2 may be implemented and performed on a computer, a processor, a microprocessor, a controller or a chip.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional 3D video apparatus, a teleconference video apparatus, and a medical video apparatus and may be used to code video signals and data signals

Furthermore, the decoding/encoding method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves, e.g., transmission through the Internet. Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1-20. (canceled)

21. A method for processing a video signal, comprising:
determining an optimal collocated picture based on a reference index of at least one of candidate blocks for predicting motion information of a current block;
predicting motion information of the current block based on information of a collocated block within the optimal collocated picture; and
generating a motion prediction signal based on the predicted motion information.

22. The method of claim 21,
wherein the information of the collocated block is obtained from an area that is set with respect to the right bottom of the collocated block.

23. The method of claim 22,
wherein the information of the collocated block comprises internal information of the collocated block, and
wherein the internal information comprises at least one of the following: a right bottom corner area; a right boundary area; a bottom boundary area; a right bottom quarter area; a right top corner area; a left bottom corner area; a center area; a preset specific area; or a combination thereof, which exist within the collocated block.

24. The method of claim 22,
wherein the information of the collocated block comprises external information of the collocated block, and
wherein the external information comprises at least one of the following: a right bottom corner area; a right boundary area; a bottom boundary area; a right bottom quarter area; a right top corner area; a left bottom corner area, a center area of the block on the right bottom; a preset specific area; or a combination thereof, which exist within the area of the blocks on the right, bottom, and right bottom adjacent to the collocated block and are adjacent to the collocated block.

25. The method of claim 21, further comprising:
receiving a flag indicating whether motion information of the optimal collocated picture is compressed or not,
wherein, when the motion information of the optimal collocated picture is compressed according to the flag, the motion information of the current block is predicted from an external area of a coding unit containing the collocated block.

26. The method of claim 25,
wherein the external area comprises at least one of the following: a right top corner area, a right bottom corner area, a left bottom corner area, or a combination thereof, which are adjacent to the coding unit.

27. The method of claim 21, further comprising:
receiving a flag indicating whether motion information of the optimal collocated picture is compressed or not,
wherein, when the motion information of the optimal collocated picture is compressed according to the flag, the motion information of the current block is predicted based on a distance between a specific position and a candidate area.

28. The method of claim 27,
wherein the specific position is preset based on the form of the collocated block or the form of a coding unit containing the collocated block.

29. The method of claim 28,
wherein, if the collocated block is in the form of 2N×nU and motion information of the optimal collocated picture is compressed to a size of N×N, the specific position is the right bottom boundary or the left top boundary.

30. The method of claim 27,
wherein the flag is received from at least one among a sequence parameter set, a picture parameter set, an adaptation parameter set, and a slice header.

31. The method of claim 22,
wherein the information of the collocated block is scaled by considering a temporal distance between the current picture containing the current block and the optimal collocated picture.

32. The method of claim 22,
wherein the candidate blocks for predicting motion information comprise at least one among an AMVP (advanced motion vector predictor) candidate block, a merge candidate block, and a neighboring block with respect to the current block.

33. An apparatus for processing a video signal, comprising
a prediction unit that determines an optimal collocated picture based on the reference index of at least one of candidate blocks for predicting motion information of a current block, predicts motion information of the current block based on information of a collocated block within the optimal collocated picture, and generates a motion prediction signal based on the predicted motion information.

34. The apparatus of claim 33,
wherein the information of the collocated block is obtained from an area that is set with respect to the right bottom of the collocated block.

35. The apparatus of claim 34,
wherein the information of the collocated block comprises internal information of the collocated block, and
wherein the internal information comprises at least one of the following: a right bottom corner area; a right boundary area; a bottom boundary area; a right bottom quarter area; a right top corner area; a left bottom corner area; a center area; a preset specific area; or a combination thereof, which exist within the collocated block.

36. The apparatus of claim 34,
wherein the information of the collocated block comprises external information of the collocated block, and
wherein the external information comprises at least one of the following: a right bottom corner area; a right boundary area; a bottom boundary area; a right bottom quarter area; a right top corner area; a left bottom corner area, a center area of the block on the right bottom; a preset specific area; or a combination thereof, which exist within the area of the blocks on the right, bottom, and right bottom adjacent to the collocated block and are adjacent to the collocated block.

37. The apparatus of claim 33,
wherein, in a case where motion information of the optimal collocated picture is compressed, the motion information of the current block is predicted from an external area of a coding unit containing the collocated block.

38. The method of claim 37,
wherein the external area comprises at least one of the following: a right top corner area, a right bottom corner area, a left bottom corner area, or a combination thereof, which are adjacent to the coding unit.

39. The apparatus of claim 33,
wherein, in a case where motion information of the optimal collocated picture is compressed, the motion information of the current block is predicted based on a distance between a specific position and a candidate area.
